(19) United States
(12) Patent Application Publication
(10) Pub. No.: US 2007/0128531 A1
(43) Pub. Date: Jun. 7, 2007

(54) Non-magnetic, ceramic one-component toner

(76) Inventors: Bernd Schultheis, Schwabenheim (DE); Holger Kobrich, Florsheim (DE); Dieter Jung, Daaden (DE)

Correspondence Address: PAULEY PETERSEN & ERICKSON, 2800 WEST HIGGINS ROAD, SUITE 365, HOFFMAN ESTATES, IL, 60195, US

(21) Appl. No.: 10/580,074

(22) PCT Filed: Nov. 17, 2004
(86) PCT No.: PCT/EP04/13031

§ 371 Date: May 22, 2006

(30) Foreign Application Priority Data
Nov. 20, 2003 (DE) 10354346.5

(51) Int. Cl. G03G 9/09

(52) U.S. Cl. 430/108.23; 430/111.41; 430/108.1; 430/111.4; 430/109.3; 430/109.4; 430/109.1; 430/108.6

(57) ABSTRACT

A non-magnetic, ceramic one-component toner which is transferred onto a glass, glass ceramics or ceramics substrate or a similar solid or flexible substrate by electrophotographic printing and is burnt into in a subsequent temperature process. The one-component toner includes a synthetic matrix and a portion of substantially inorganic foreign matter. The portion of foreign matter includes exclusively non-magnetic particles and amounts to 40 to 70% by weight, especially 50 to 60% by weight, with the specific charge of the toner particles in a range of >25 μCk/g.

### BACKGROUND OF THE INVENTION

1. Field of the Invention

This invention relates to a non-magnetic, ceramic one-component toner, which can be transferred by electro-photographic printing to a glass, glass-ceramic or ceramic substrate or similar rigid or flexible substrate and which can be fired in a subsequent temperature process, and which contains a substantially inorganic proportion of a foreign substance besides a plastic matrix.

2. Discussion of Related Art

Magnetic or non-magnetic ceramic one-component toners are known. Magnetic toners are difficult to handle, they are noted for poor transfer and fixation capabilities. Customary non-magnetic toners have only a small proportion of foreign substances, besides a large proportion of a plastic matrix. Such non-magnetic toners primarily contain a small amount of color pigments for color printing. However, the customary non-magnetic toners are not well suited for coating surfaces with layers of gold, silver, copper or gemstone, for example, because a correspondingly high proportion of foreign substances, such as gold or gemstone, cannot be handled.

A method for producing a printed electrical circuit is known from German Patent Reference DE 199 42 054 A1, in which a toner is applied to a substrate by electrographic or electrostatic methods. For example, strip conductors of gold are applied. If using a magnetic toner, the magnetic particles would affect the electrical properties of such strip conductors. But it is not possible to increase the proportion of gold to a sufficiently high level with customary non-magnetic toners.

Similar problems arise, for example, when coating surfaces with a layer of gemstone for increasing the resistance of the surface to be coated. With such coating, the proportion of gemstone, for example Al₂O₃, ZiO₂ or the like, of the toner used should be as high as possible.

### SUMMARY OF THE INVENTION

It is one object of this invention to provide a toner of the type mentioned above but which can be employed in electro-photographic direct printing on a glass, glass-ceramic or ceramic substrate or similar rigid or flexible substrate, wherein a composition of the toner does not affect the electrical or magnetic properties, in particular of the coating to be applied. During this, the toner in accordance with this invention should be distinguished by good transfer and fixation properties, and should have a particularly large proportion of foreign substances for forming a coating.

In accordance with this invention, this object is achieved with a proportion of foreign substances that exclusively contains non-magnetic particles and amounts to >30 to 80 weight-%, in particular 50 to 60 weight-%, wherein the specific charge of the toner particles lies in a range of >25 μC/g.

This toner is particularly suited for imprinting or coating rigid or flexible substrates, wherein the problems with regard to electrical or magnetic properties of the coating do not occur because of the use of exclusively non-magnetic particles. Because of the particularly high proportion of foreign materials, the resulting coating can be applied particularly homogeneously.

In this case the proportion of foreign materials can comprise glass flow particles and/or pigment particles and/or charge control particles.

The particle size of the toner particles, in particular the glass flow particles and/or pigment particles used, lies in the range of 1 to 12 μm (D50 vol), particularly in the range of 3 to 8 μm. The desired coating or printing qualities occur with such a particle size, wherein the proportion of wax preferably lies in the range of 1 to 10 weight-%, particularly in the range of 3 to 7 weight-%.

The toner can contain glass flow particles from a specific glass frit in the range of >30 to 80 weight-%, in particular 45 to 60 weight-%.

In addition, inorganic pigments in the range of 0 to <20 weight-%, in particular 5 to <20 weight-%, can be provided. The proportion of the used plastic matrix can lie in the range of 20 to 60 weight-%, in particular >30 to 50 weight-%. The above statements refer to the total mass of the toner.

In one particularly advantageous embodiment, the proportion of the charge control materials used in the plastic matrix should lie in the range of 1 to 5 weight-%.

The toner can have a thermoplastic matrix in particular, which homogeneously melts on the substrate in the temperature range of 100° C. to 400° C., in particular in the temperature range of 110° C. to 150° C. In the temperature range starting at 300° C. up to 500° C., the thermoplastic matrix can evaporate with almost no residue and/or burn off. The toner can also contain auxiliary materials to aid flow, with whose use the wetting of the substrates to be imprinted can be controlled.

The plastic matrix as the support of the inorganic glass frits and pigments can be matched to the firing process by the selection of the melting, the decomposition and/or evaporation temperature of the plastic material used in such a way, that prior to burning off the plastic material melts homogeneously onto the substrate and then evaporates and/or decomposes and in the process does not hinder the melting-together of the glass flow and color pigment particles. The toner image can be transferred by electro-photographic printing directly to the substrate, wherein a removal free of residue of the carrier material is assured during the firing process.

In this disclosure, weight-% relates to the total weight of the one-component toner.

It is also possible for the toner to be indirectly transferred. In this case a transfer medium, for example a paper coated with gum arabic and/or wax, is used.

In accordance with one embodiment, the plastic matrix contains toner resins on a polyester basis and/or acrylate basis, in particular styrene acrylate, polymethylmethacrylate, or made of the cycloolefin copolymer Topas® of the Ticona company. These materials are easy to process and have satisfactory adhesion on the substrate. Also, these materials burn without leaving a residue.

The de-polymerization, the melting temperature, the evaporation and/or the decomposition temperatures can be affected by the selection of different polymers for the plastic matrix. Polyvinyl alcohol, polyoxymethylene, styrene copolymers, polyvinylidene fluoride, polyvinyl butyral, polyesters (unsaturated and/or saturated, or mixtures thereof), polycarbonate, polyvinyl pyrrolidone, vinyl imidazole copolymers, as well as polyether, have shown themselves to be suitable materials.

Also, for improving the image or structure transfer, or for the decomposition of the organic materials without residue, the toner can also contain charge control materials and/or oxidation materials, in a known manner. The added oxidation materials accelerate the decomposition of the plastic matrix.

For improving the wetting when the toner melts on the surface which, as a rule, is relatively polar and smooth and, in contrast to paper, not absorbent, the toner is also coated with additives. With a suitable selection of known additives, it is possible to control the polarity of the toner, and thus the wetting of the substrates, between non-polar, hydrophobic, neutral, polar, hydrophilic. Thus, it is possible to make use of known auxiliary materials to aid flow, such as aerosils and auxiliary transfer means, for improving the quality of printing. The proportion of such auxiliary media lies between 0 and 1.0 weight-%, typically between 0.2 and 0.5 weight-%.

For breaking down the polymers, or for depolymerization, peroxides or azo compounds can be added to the toner which, however, have decomposition temperatures of >150° C., so that the decomposition does not already start in the melting-open phase, or the fixation phase. Also, inorganic additives are also possible, such as catalytically acting pigments, for example, which accelerate the decomposition of the organic plastic matrix. Examples of this are the so-called perovskites of the general form ABO₃, for example LaMnO₃, LaCoO₃, La_{α}Sr_{β}, Co_{gamma}Mn_{delta}O_{epsilon+E}.

The following tables show exemplary embodiments of glass compositions, frits or also glass flows, which are particularly suitable for a ceramic toner. The weight-% information relates to the composition of the glass frit.

The glass compositions 1 to 6 are particularly suitable for glass and glass-ceramic material.

| | | Glass | Glass | Glass | Glass | Glass |
|---|---|---|---|---|---|---|
| | Glass | Composition | Composition | Composition | Composition | Composition |
| | Composition1 | 2 | 3 | 4 | 5 | 6 |
| | Weight-% | Weight-% | Weight-% | Weight-% | Weight-% | Weight-% |
| Li₂O | 0 . . . 6.0 | 0 . . . 5.0 | 2.0 . . . 4.0 | 0 . . . 2.0 | 0 . . . 3.0 | 0.1 . . . 1.5 |
| Na₂O | 0 . . . 5.0 | 0 . . . 5.0 | 5.0 . . . 9.5 | 0 . . . 5.0 | 0 . . . 2.5 | 7.0 . . . 13.0 |
| K₂O | 0 . . . 2.0 | 0 . . . 2.5 | 1.5 . . . 4.0 | 0 . . . 5.0 | 0 . . . 8.0 | 0 . . . 1.5 |
| MgO | 0 . . . 4.0 | 0 . . . 3.0 | 0 . . . 0.5 | 0 . . . 0.5 | 0 . . . 8.5 | |
| CaO | 0 . . . 4.0 | 0 . . . 4.0 | 0.0 . . . 0.1 | 0 . . . 1.0 | 0.5 . . . 4.0 | |
| SrO | 0 . . . 4.0 | 0 . . . 4.0 | | | | |
| BaO | 0 . . . 1.0 | 0 . . . 4.0 | | | 0 . . . 28.0 | 2.0 . . . 4.0 |
| ZnO | 0 . . . 4.0 | 0 . . . 4.0 | | 0 . . . 10.0 | 1.0 . . . 15.0 | |
| B₂O₃ | 13.0 . . . 23.0 | 15.0 . . . 27.0 | 13.0 . . . 20.0 | 1.0 . . . 10.0 | 4.0 . . . 26.0 | 17.0 . . . 22.0 |
| Al₂O₃ | 3.0 . . . 10.0 | 7.0 . . . 20.0 | 5.0 . . . 10.0 | 0.5 . . . 10.0 | 2.5 . . . 18.0 | 4.0 . . . 8.0 |
| Bi₂O₃ | 0 . . . 2.5 | 0 . . . 2.5 | | | | |
| La₂O₃ | 0 . . . 3 | 0 . . . 0.9 | | | | |
| SiO₂ | 50.0 . . . 65.0 | 43.0 . . . 58.0 | 41.0 . . . 59.0 | 20.0 . . . 45.0 | 40.0 . . . 62.0 | 55.0 . . . 65.0 |
| TiO₂ | 0 . . . 4.0 | 0 . . . 3.0 | | 0 . . . 0.5 | | |
| ZrO₂ | 0 . . . 4.0 | 0 . . . 4.0 | 2.0 . . . 5.5 | 0 . . . 1.0 | 0 . . . 2.5 | |
| SnO₂ | 0 . . . 2.0 | 0 . . . 2.0 | | 0 . . . 3.0 | | |
| P₂O₅ | 0 . . . 1.5 | 0 . . . 2.5 | | | | |
| Sb₂O₃ | 0 . . . 2.0 | 0 . . . 2.5 | | | | |
| F | 0 . . . 4.0 | 0 . . . 3.0 | 0 . . . 4.0 | | | 0 . . . 3.5 |
| CeO₂ | | | | 0 . . . 10.0 | | |
| PbO | | | | 20.0 . . . 60.0 | | |
| CdO | | | | 0 . . . 1.5 | | |
| T_{g} (° C.) | 400 . . . 650 | 450 . . . 650 | | | | |
| E_{w} (° C.) | 580 . . . 830 | 600 . . . 850 | | | | |
| V_{A} (° C.) | 840 . . . 1100 | 880 . . . 1150 | | | | |
| | α_{20-700° C.} | α_{20-700° C.} | | | | |
| | (10 − ⁶K) < 2.0 | (10 − ⁶K) | | | | |
| | α_{20-300° C.} | 3.5-7.0 | | | | |
| | (10 −⁶K) 3.5-8.0 | | | | | |

Special exemplary embodiments of the glass composition 1 are:

GLASS COMPOSITION 1

| | Exemplary | Exemplary | Exemplary | Exemplary | Exemplary | Exemplary | Exemplary |
|---|---|---|---|---|---|---|---|
| | Embodiment | Embodiment | Embodiment | Embodiment | Embodiment | Embodiment | Embodiment |
| | 1 | 2 | 3 | 4 | 5 | 6 | 6 |
| | Weight-% | Weight-% | Weight-% | Weight-% | Weight-% | Weight-% | Weight-% |
| Li₂O | 2.0 | 3.0 | 4.4 | 2.0 | 2.0 | 3.3 | 4.6 |
| Na₂O | 4.0 | 2.0 | | 4.0 | 4.0 | 4.0 | 4.1 |
| K₂O | 1.0 | 1.0 | | | 1.3 | | |
| MgO | 2.0 | | 1.2 | 1.0 | | 1.0 | 0.9 |
| CaO | | | 2.0 | | 3.0 | 0.7 | 1.3 |
| SiO | 3.0 | | 2.0 | 1.0 | | 1.4 | 1.8 |
| BaO | | 1.0 | 1.0 | | | | |
| ZnO | 3.0 | 1.0 | 3.0 | 2.0 | | 1.1 | 0.2 |
| B₂O₃ | 22.0 | 17.0 | 17.6 | 20.0 | 22.0 | 19.9 | 17.5 |
| Al₂O₃ | 6.0 | 8.8 | 9.0 | 6.4 | 9.8 | 6.0 | 6.0 |
| Bi₂O₃ | | | 2.0 | | 1.4 | | |
| La₂O₃ | | 1.0 | | | 2.6 | | |
| SiO₂ | 55.0 | 61.4 | 54.0 | 61.0 | 52.0 | 60.5 | 60.3 |
| TiO₂ | | 2.0 | | | | | |
| ZrO₂ | 2.0 | | 1.0 | | | 1.0 | 2.1 |
| SnO₂ | | | | 1.0 | 1.5 | | |
| P₂O₅ | | | | 1.0 | | | |
| Sb₂O₃ | | 1.8 | 0.8 | | 0.4 | | |
| F | | | 2.0 | 0.6 | | 1.1 | 1.2 |
| T_{g} (° C.) | 510 | 490 | 485 | 485 | 525 | 475 | 475 |
| E_{w} (° C.) | 670 | 675 | 685 | 695 | 675 | 660 | 630 |
| V_{A} (° C.) | 925 | 985 | 885 | 987 | 930 | 900 | 873 |
| α_{20-300° C.} | 5.5 | 5.0 | 5.3 | 5.0 | 5.8 | 5.5 | 6.2 |
| (10 − ⁶K) | | | | | | | |

Special exemplary embodiments of the glass composition 2 are:

GLASS COMPOSITION 2

| | Exemplary | Exemplary | Exemplary | Exemplary | Exemplary | Exemplary | Exemplary |
|---|---|---|---|---|---|---|---|
| | Embodiment | Embodiment | Embodiment | Embodiment | Embodiment | Embodiment | Embodiment |
| | 1 | 2 | 3 | 4 | 5 | 6 | 6 |
| | Weight-% | Weight-% | Weight-% | Weight-% | Weight-% | Weight-% | Weight-% |
| Li₂O | 4.0 | 2.0 | 3.1 | 2.8 | 3.0 | 3.0 | |
| Na₂O | 3.0 | 4.0 | | 1.5 | 1.0 | | 1.6 |
| K₂O | | | | | | | 7.2 |
| MgO | 1.0 | 1.0 | 1.7 | 0.4 | 1.5 | 1.5 | |
| CaO | 2.0 | 2.0 | 2.0 | | 2.0 | 1.5 | 3.6 |
| SiO | | | 2.3 | | | 2.0 | |
| BaO | | | | 3.7 | 1.0 | | |
| ZnO | 2.0 | | 2.2 | 1.0 | 2.0 | 2.0 | 1.5 |
| B₂O₃ | 19.0 | 19.0 | 16.7 | 17.3 | 17.5 | 17.0 | 24.4 |
| Al₂O₃ | 12.5 | 19.0 | 16.6 | 17.1 | 16.0 | 17.0 | 17.5 |
| Bi₂O₃ | | | | | | | |
| La₂O₃ | | | | | 0.5 | | |
| SiO₂ | 55.0 | 51.0 | 54.3 | 52.0 | 53.0 | 52.0 | 42.2 |
| TiO₂ | 1.0 | 2.0 | | 1.9 | | | |
| Zr0₂ | 0.5 | | 1.1 | 1.0 | 1.0 | 1.0 | 2.0 |
| SnO₂ | | | | | 1.5 | | |
| P₂O₅ | | | | | | 2.0 | |
| Sb₂O₃ | | | | 1.3 | | | |
| F | | | | | | 1.0 | |
| T_{g} (° C.) | 509 | 533 | 578 | 529 | 539 | 523 | 541 |
| E_{w} (° C.) | 655 | 741 | 755 | 765 | 724 | 730 | 762 |
| V_{A} (° C.) | 914 | 1062 | 1064 | 1081 | 1024 | 1062 | 1069 |
| α_{20-300° C.} | 5.65 | 5.18 | 4.41 | 4.86 | 4.68 | 4.3 | 5.89 |
| (10 − ⁶K) | | | | | | | |

The glass composition 7 is particularly suited for glass-ceramic articles with secondary firing.

| | Glass |
|---|---|
| | Composition |
| | 7 |
| | Weight-% |
| Li₂O | 2.0 . . . 5.0 |
| Na₂O | 1.0 . . . 2.5 |
| K₂O | 1.0 . . . 3.0 |
| MgO | 0 . . . 1.5 |
| BaO | 0 . . . 4.0 |
| ZnO | 0 . . . 1.0 |
| B₂O₃ | 10.0 . . . 20.0 |
| Al₂O₃ | 5.0 . . . 10.0 |
| SiO₂ | 60.0 . . . 70.0 |
| TiO₂ | 0 . . . 2.0 |
| ZrO₂ | 0 . . . 2.0 |

The glass composition 8 to 10 is particularly suited for glass.

| | Glass | Glass | Glass |
|---|---|---|---|
| | Composition | Composition | Composition |
| | 8 | 9 | 10 |
| | Weight-% | Weight-% | Weight-% |
| Li₂O | 0 . . . 7.0 | 2.0 . . . 5.0 | |
| Na₂O | 2.0 . . . 8.0 | 5.0 . . . 10.0 | 3.0 . . . 10.0 |
| K₂O | 0 . . . 5.0 | | |
| MgO | | 0 . . . 2.0 | 0 . . . 2.0 |
| CaO | 0 . . . 3.0 | 1.0 . . . 7.0 | 2.0 . . . 5.0 |
| SrO | 0 . . . 3.0 | 0 . . . 2.0 | |
| BaO | | | 0.5 . . . 3.0 |
| ZnO | 2.0 . . . 10.0 | 7.0 . . . 13.0 | 6.0 . . . 13.0 |
| B₂O₃ | 20.0 . . . 32.0 | 14.0 . . . 26.0 | 20.0 . . . 40.0 |
| Al₂O₃ | 1.0 . . . 15.0 | 4.0 . . . 16.0 | |
| Bi₂O₃ | 0 . . . 10.0 | | |
| SiO₂ | 24.0 . . . 40.0 | 30.0 . . . 50.0 | 45.0 . . . 70.0 |
| TiO₂ | | 0 . . . 4.0 | 0 . . . 20 |
| ZrO₂ | | 0 . . . 3.0 | |
| Sb₂O₃ | | | 0 . . . 0.5 |
| F | | 0 . . . 3.0 | 0 . . . 4.0 |
| PbO | | | 0 . . . 2.0 |

The glass composition 11 to 12 is particularly suited for ceramics, stoneware, bone china and porcelain.

| | Glass | Glass |
|---|---|---|
| | Composition | Composition |
| | 11 | 12 |
| | Weight-% | Weight-% |
| Li₂O | 2.5 . . . 4 | 0.9 . . . 7.4 |
| Na₂O | 2.7 . . . 7.4 | 1.6 . . . 8.2 |
| K₂O | 2.9 . . . 8.0 | 0.5 . . . 6.1 |
| MgO | 0 . . . 0.5 | 0 . . . 4.0 |
| CaO | 0 . . . 0.5 | 0.4 . . . 4.5 |
| SrO | | 0 . . . 4.0 |
| BaO | 0 . . . 0.5 | |
| ZnO | 0 . . . 1.5 | 0.4 . . . 3.8 |
| B₂O₃ | 14.5 . . . 18.5 | 11.0 . . . 36.4 |
| Al₂O₃ | 3.0 . . . 5.0 | 2.0 . . . 14.6 |
| La₂O₃ | | 0 . . . 3.0 |
| SiO₂ | 53.0 . . . 70.0 | 28.0 . . . 69.0 |
| TiO₂ | 0 . . . 0.5 | 0 . . . 6.0 |
| ZrO₂ | 5.5 . . . 13.5 | 1.3 . . . 20.6 |
| SnO₂ | | |
| P₂O₅ | 0 . . . 0.5 | 0 . . . 10.0 |
| Sb₂O₃ | | |
| F | | 0 . . . 8.0 |
| SO₃ | 0 . . . 0.5 | |
| Fe₂O₃ | 0 . . . 0.5 | |
| Y₂O₃ | 0 . . . 0.5 | 0 . . . 1.0 |
| CeO₂ | 0 . . . 0.5 | |
| PbO | | 0 . . . 1.5 |
| Further Rare | | 0 . . . 1.0 |
| Earth Metal | | |
| Oxides | | |
| T_{g} (° C.) | | 470 . . . 610 |
| α_{20-300° C.} | | 5.0 . . . 8.0 |
| (10 −⁶K) | | |

In this connection properties of the glass frits are mentioned at least for the composition areas 1 and 2, which are particularly tuned to the direct imprinting of glass-ceramic articles of a coefficient of expansion of less than 2×10⁻⁶ K⁻¹, within the temperature range of 20 to 700° C. Depending on the case of application, mixtures of the above mentioned glass frits are also possible.

Based on the properties of the glass frits, they are therefore particularly suited in connection with appropriate inorganic pigments for electro-photographically imprinting plates of special glass, such as for example soda-lime glass or boro-silicate glass, if needed, previously coated, for example, with SiO₂ and/or TiO₂, or with one of the above mentioned glass frits, for example for applications as outer oven windows, inner oven windows, bottom inserts for refrigerators, glass for display cases, etc., as well as for direct imprinting of glass-ceramic articles with low expansion properties, for example for applications as glass-ceramic cooking or grilling surfaces or fireplace windows. But it is also possible to imprint ceramic surfaces, such as floor tiles or sanitary objects, in this way. Requirements in regard to wear resistance, adhesion and chemical resistance can each be taken into consideration by the glass frit composition in accordance with the above tables.

Typically, inorganic compounds are considered as color pigments, such as for example metal oxides, mixed phases of metal oxide pigments or CIC pigments, complex inorganic color pigments, inclusion pigments, metal powders or metal flakes, metal colloids, pearl glow or luster pigments on the basis of small mica or glassy or SiO₂ or Al₂O₃ plates, fluorescent pigments, magnetic pigments, anti-corrosion pigments, transparent pigments, sintered-in pigments and/or mixtures of pigments with glass frits, pigments for four-color sets, etc., or mixtures of the above mentioned variants, which are sufficiently described in the literature, for example, “Ullmann's Encyclopedia of Industrial Chemistry”, vol. A20, 1992, VCH publishers, Inc. The pigments can be based on the most different crystalline structures, such as rutile, spinel, zirconium, baddeleyte, cassiterite, corundum, garnet, sphene, pyrochlore, olivine, phenacite, periclase, sulfide, perovskite, and the like.

In this case, the typical size of the glass flow particles and the inorganic pigments lies in the range of 0.5 to 25 μm (D50 vol.), in particular in the range of 1 to 10 μm. Examples of grinding methods for producing such particles are counterflow grinding, grinding in ball, annular gap or pinned disk mills.

The glass flow particles, as well as the pigments, are typically only partially, i.e. incompletely, enclosed in the plastic matrix because of the production process and as a rule have an irregular shape. One reason for this is that the inorganic components, such as glass flow and pigments, have a different fracture toughness in comparison with the organic plastic matrix and preferably break open at the grain boundaries during the grinding process of the toner. Additives or auxiliary materials to aid flow, which are added later, are deposited on the surface of the plastic matrix or on the exposed flow and/or pigment particles.

The foreign substance used can be selected from one or several of the materials gold, silver, copper, gemstone, such as Al₂O₃, ZrO₂, or particles of that type, or another non-magnetic material.

The one-component toner, IC toner, in accordance with this invention can be transferred electrostatically without the aid of magnetic carrier particles to the photo-conductor of an electro-photographic printing device, by which an image quality is obtained which is improved with respect to resolution and sharpness.

1. A non-magnetic, ceramic one-component toner, which can be transferred by electro-photographic printing to a glass, a glass-ceramic substrate, a ceramic substrate or a similar rigid or flexible substrate and can be fired in a subsequent temperature process and which contains a substantially inorganic proportion of a foreign substance other than a plastic matrix, the toner comprising:
the proportion of the foreign substance exclusively containing non-magnetic particles and being >30 to 80 weight-%, in particular 50 to 60 weight-%, wherein a specific charge of toner particles lies in a range of >25 μC/g.

2. The toner in accordance with claim 1, wherein the proportion of foreign substance comprises at least one of glass flow particles, pigment particles and charge control particles.

3. The toner in accordance with claim 2, wherein a particle size of the toner particles, in particular at least one of the glass flow particles and the pigment particles, lies in a range of 1 to 12 μm (D50 vol), in particular of 3 to 8 μm.

4. The toner in accordance with claim 3, wherein a proportion of wax is in a range of 1 to 10 weight-%, in particular of 3 to 7 weight-%.

5. The toner in accordance with claim 4, wherein the toner contains at least one of glass flow particles from a specific glass frit in a range of >30 to 80 weight-%, in particular 45 to 60 weight-%, inorganic pigments in a range of 0 to <20 weight-%, in particular 5 to <20 weight-%, and a plastic matrix in the range of 20 to 60 weight-%, in particular >30 to 50 weight-%.

6. The toner in accordance with claim 5, wherein the toner contains charge control materials as additives in the plastic matrix, having a proportion in a range of 1 to 5 weight-%.

7. The toner in accordance with claim 6, wherein the toner has a thermoplastic matrix which homogeneously melts on a substrate in a temperature range of 100° C. to 400° C., in particular 110° C. to 150° C.

8. The toner in accordance with claim 7, wherein in a temperature range of 300° C. up to 500° C., the plastic matrix at least one of evaporates with almost no residue and burns off.

9. The toner in accordance with claim 8, wherein the plastic matrix contains toner resins on at least one of a polyester basis and an acrylate basis, in particular one of styrene acrylate, polymethylmethacrylate, and a cycloolefin copolymer.

10. The toner in accordance with claim 9, wherein the plastic matrix contains at least one of polymers, including polyvinyl alcohol, polyoxymethylene, styrene copolymers, polyvinylidene fluoride, polyvinyl butyral, polyesters that are at least one of unsaturated and saturated, or mixtures thereof, polycarbonate, polyvinyl pyrrolidone, vinyl imidazole copolymers, and polyether.

11. The toner in accordance with claim 10, wherein the toner contains an oxidation as additives.

12. The toner in accordance with claim 11, wherein the toner is also coated with auxiliary materials to aid flow, including aerosils.

13. The toner in accordance with claim 12, wherein the additives and the auxiliary materials to aid flow are added in amounts of respectively 0 and 1.0 weight-%, in particular 0.2 to 0.5 weight-%.

14. The toner in accordance with claim 13, wherein the toner particles have an irregular shape and are only partially enclosed by the plastic matrix.

15. The toner in accordance with claim 14, wherein for breaking down the polymers the toner has at least one of peroxides and azo compounds with decomposition temperatures of >150° C.

16. The toner in accordance with claim 15, wherein the toner is applied to a transfer medium.

17. The toner in accordance with claim 16, wherein the transfer medium is a support coated with a gum arabic.

18. The toner in accordance with claim 17, wherein the foreign substance is a gemstone including at least one of Al₂O, ZrO₂, gold, silver, copper and a similar non-magnetic material.

19. The toner in accordance with claim 1, wherein a particle size of the toner particles, in particular at least one of glass flow particles and pigment particles, lies in a range of 1 to 12 μm (D50 vol), in particular of 3 to 8 μm.

20. The toner in accordance with claim 1, wherein a proportion of wax is in a range of 1 to 10 weight-%, in particular of 3 to 7 weight-%.

21. The toner in accordance with claim 1, wherein the toner contains at least one of glass flow particles from a specific glass frit in a range of >30 to 80 weight-%, in particular 45 to 60 weight-%, inorganic pigments in a range of 0 to <20 weight-%, in particular 5 to <20 weight-%, and a plastic matrix in the range of 20 to 60 weight-%, in particular >30 to 50 weight-%.

22. The toner in accordance with claim 1, wherein the toner contains charge control materials as additives in the plastic matrix, having a proportion in a range of 1 to 5 weight-%.

23. The toner in accordance with claim 1, wherein the toner has a thermoplastic matrix which homogeneously melts on a substrate in a temperature range of 100° C. to 400° C., in particular 110° C. to 150° C.

24. The toner in accordance with claim 1, wherein in a temperature range of 300° C. up to 500° C., the plastic matrix at least one of evaporates with almost no residue and burns off.

25. The toner in accordance with claim 1, wherein the plastic matrix contains toner resins on at least one of a polyester basis and an acrylate basis, in particular one of styrene acrylate, polymethylmethacrylate, and a cycloolefin copolymer.

26. The toner in accordance with claim 1, wherein the plastic matrix contains at least one of polymers, including polyvinyl alcohol, polyoxymethylene, styrene copolymers, polyvinylidene fluoride, polyvinyl butyral, polyesters that are at least one of unsaturated and saturated, or mixtures thereof, polycarbonate, polyvinyl pyrrolidone, vinyl imidazole copolymers, and polyether.

27. The toner in accordance with claim 1, wherein the toner contains an oxidation as additives.

28. The toner in accordance with claim 1, wherein the toner is also coated with auxiliary materials to aid flow, including aerosils.

29. The toner in accordance with claim 10, wherein the additives and the auxiliary materials to aid flow are added in amounts of respectively 0 and 1.0 weight-%, in particular 0.2 to 0.5 weight-%.

30. The toner in accordance with claim 1, wherein the toner particles have an irregular shape and are only partially enclosed by the plastic matrix.

31. The toner in accordance with claim 1, wherein for breaking down the polymers the toner has at least one of peroxides and azo compounds with decomposition temperatures of >150° C.

32. The toner in accordance with claim 1, wherein the toner is applied to a transfer medium.

33. The toner in accordance with claim 32, wherein the transfer medium is a support coated with a gum arabic.

34. The toner in accordance with claim 1, wherein the foreign substance is a gemstone including at least one of Al₂O₃, ZrO₂, gold, silver, copper and a similar non-magnetic material.
